(19) United States
(12) Patent Application Publication
(10) Pub. No.: US 2020/0231359 A1
(43) Pub. Date: Jul. 23, 2020

(54) Herb, Hemp and Cannabis Film

(71) Applicant: Keith W. Donaldson, Buffalo Grove, IL (US)

(72) Inventor: Keith W. Donaldson, Buffalo Grove, IL (US)

(21) Appl. No.: 16/749,050

(22) Filed: Jan. 22, 2020

Related U.S. Application Data
(60) Provisional application No. 62/795,183, filed on Jan. 22, 2019.

(51) Int. Cl. B65D 81/24; A01N 59/20; B65D 65/38

(52) U.S. Cl. CPC B65D 81/24; B65D 65/38; A01N 59/20

(57) ABSTRACT

Polymer or polymer inks are used for reducing or eliminating harmful chemicals by offering a neutralizing chemical in the path of movement of the harmful chemicals. A neutralizing chemical responsive to the harmful chemical produces a harmless chemical as an output that is in the path of the harmful chemical and is opposite phase with the neutralizing chemical, preferably by 180 degrees, or is at least opposite in chemical compatibility to some extent. The neutralizing chemical can be suspended or combined with an inert carrier and preferably attenuates the harmful chemical concentration. The polymer ink can be applied to a media such as paper, (embossed or extruded) or polymer the same as paper but also in foam (open cell preferred) in order to obtain a decrease in the concentration of harmful gases. These forms can be utilized in air or liquid applications. Uses can be as diverse as but not limited to interior cleansing of boxes, cartons, and containers to air conditioning moving air applications in dynamic environments.

### RELATED APPLICATIONS

The present application claims the priority of U.S. Provisional Application Ser. No. 62/795,183 filed Jan. 22, 2019, which is fully incorporated herein by reference.

### FIELD OF THE INVENTION

The present inventions relate to a method and composition for neutralizing gases in the environment that speed up ripening of herbs and cannabis, and for neutralizing chemicals being given off by those items.

### BACKGROUND OF THE INVENTION

Various chemicals generate gases that can speed the degradation or ripening process of herbs and cannabis. Additionally, in the curing process for herbs and cannabis, often gases are emitted that can either speed the ripening (aging/degradation) process or can damage the materials if left in the packaging with the product. These gases coming from the curing process of cannabis and other herbs are nitrogen-based gases, among others. Additionally, mold and mildew readily can grow on these herbs, since they retain moisture.

The functionality, reliability, aesthetics, or useable life of the materials of interest are compromised by all of these. Previously, such materials have been enclosed in a covering with a type of coating to impede harmful chemical reactants such as atmospheric gaseous contaminants whether naturally occurring or man-made. These coatings are typically used to impede the harmful chemicals from reacting with the surfaces under protection by providing a barrier which relies on the polymer or other type of coating to utilize the permeation characteristics of the inert membrane of the protective media to provide the buffer between the harmful chemical and the surfaces under protection.

### SUMMARY OF THE INVENTION

In accordance with the present inventions, polymers or polymer based inks are provided that use an inert carrier to hold a neutralization chemical, preferably copper particles. The neutralizing chemicals use the chemistry and biological function of copper to inhibit mold and mildew, but by the selection of a high surface area copper particle, they can also be used to neutralize the gases in the environment that speed up ripening of herbs and cannabis, as well as to neutralize chemicals being given off by these items. The harmful chemicals can be in gaseous or liquid form. The inert carrier can be in sheet, foam, woven thread, mesh, extrusions, or other forms or shapes that offer a significant contact surface area to actual external area size or weight ratio. In preferred embodiments, the nitrogen-based gases being expelled from the herbs will react with copper particles in the packaging and be neutralized.

### DETAILED DESCRIPTION OF THE INVENTIONS AND THE PREFERRED EMBODIMENTS

In accordance with preferred embodiments of the present inventions packaging is provided for the protection of herbs and cannabis to provide protection against mold and mildew in the short term, and/or to provide shelf life extension and enhancement of the items packaged. Preferably, the herb and cannabis materials are packaged within copper-based films. Experimentation has shown both short term and long-term advantages gained from using this packaging technique and films.

According to the inventions, copper particles are suspended in a polymer that can then be made into films, laminates, thermoformed trays, or totes or injection-molded parts. Additionally, the copper polymer can be made into a coating that can be coated or printed onto paper or other substrates. The copper is bound in place, as testing has shown, but is available to prevent the growth of mold and mildew in contact with the film. Additionally, long-term storage shows the maintenance of key attributes of the items being stored in the films.

In a reactive embodiment, the copper can be physically or chemically suspended, coated, impressed into, or otherwise combined into, or on a material or surface to be protected or onto a carrier material, such as a paper or polymer sheet, and may be used as a wrapping or liner for the interior of an enclosure for the item to be protected. For open unenclosed environments, the items to be protected may have a favorable environment developed by the inventions by reducing the harmful chemicals in the air by attaching the ink to a filtration media comprised of a woven polymer, a paper, or a foam media. Alternatively, the copper can be an internal layer of a multi-layer film or material. This type of structure can hold multiple neutralization chemicals in separate layers to perform unique combinations of reactions to provide neutralization of multiple harmful reactive chemicals.

In accordance with the present inventions, by placing neutralizing chemicals in the path, the harmful chemicals must take to come in contact with the surfaces under protection. Thus, the protection afforded by the inventions offers orders of magnitude more protection than various prior methods. It should be noted that the reactants produced with the copper and the various gases preferably remains in the polymer or on the surface with the ink. The resultant chemicals are kept away from the items being protected.

The basis for the reactions follows the following rules:

Synthesis: A synthesis reaction is when two or more simple compounds combine to form a more complicated one. These reactions come in the general form of:

A+B→AB

One example of a synthesis reaction is the combination of copper and sulfur to form Copper (I) sulfide:

2Cu+S→Cu₂S

Likewise, there are many potential reactions with ozone and copper and nitrogen based chemicals (primarily ammonia) with copper:

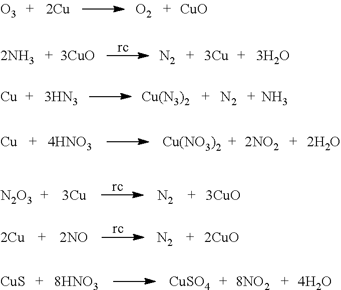

Any of these reactions can be used in accordance with the present invention.

Having described the inventions with respect to particular embodiments, it is to be understood that the description is not meant as a limitation, since numerous other modifications and variations may be made to the inventions or may suggest themselves. It is intended that the present inventions and application cover all such modifications and variations. Moreover, the information in each paragraph relates to and is intended to be used in conjunction with the inventions as disclosed in all other paragraphs herein and in conjunction with the information presented in the related applications.

What is claimed is:

1. A composition comprising:
neutralizing chemicals forming a shield for herbal material, to effectively offer a plurality of reactive sites that may be of opposite, or even slightly different chemical potential than a harmful gas, comprising,
a substantially high surface area in which the neutralizing gas induces a harmful chemical to react with, and be transformed into a harmless chemical;
a substantially high surface area in which the neutralizing gas induces a harmful chemical to react with, and be transformed into a harmless chemical and at least partly nullifies one another, thereby reducing the harmful chemical content below the original concentration.

2. The composition of claim 1, wherein the neutralizing chemical is at least partly comprised of a neutralizing chemical at least partly offering neutralization

3. The composition of claim 1, wherein the neutralizing chemical comprises a barrier spaced from the air flow path and said harmful chemical beyond the media is along the air flow path.

4. The composition of claim 3, wherein the neutralizing barrier comprises at least one of inert carrier and neutralizing chemical in combination with additional layers or combinations of said neutralizing chemicals and inert carriers.

5. The composition of claim 1, wherein the inert carriers can be paper, polymer, or other inert materials with at least a 1 to 1 surface to exposed area but preferably greater than 1 to 1 such as by embossing, extruding, foaming, or others shapes that can offer a significantly greater than 1 to 1 surface to exposed area ratio.
